(19) United States
(12) Patent Application Publication
(10) Pub. No.: US 2008/0116013 A1
(43) Pub. Date: May 22, 2008

(54) High Lift Truck

(76) Inventors: Stephen C. Vandewinckel, Livonia, NY (US); Francis W. Wenzel, Fairport, NY (US); Guy W. Boor, Geneseo, NY (US)

Correspondence Address: JACOBSON HOLMAN PLLC, 400 SEVENTH STREET N.W., SUITE 600, WASHINGTON, DC, 20004, US

(21) Appl. No.: 11/629,359

(22) PCT Filed: Jun. 18, 2004
(86) PCT No.: PCT/US04/19237

§ 371 Date: Dec. 11, 2007

(51) Int. Cl. B66F 9/08; B62D 33/033

(52) U.S. Cl. 187/229; 296/59

(57) ABSTRACT

A self-propelled, operator controlled, load lifting and transporting vehicle including a mobile frame (96) supported by front and rear wheel assemblies (24, 26) at the front and rear of the frame and a drive motor (116) driving a hydrostatic drive system to drive a pair of transversely spaced front wheels (24). A pair of closely spaced rear wheels (26) are supported from the frame and includes a steering structure (106) oriented to enable operator control. A vertical mast (28) is supported at the front of the frame by a transverse, generally horizontal pivotal structure including a hydraulically operated piston and cylinder assembly (90) to vary the forward and rearward tilt of the mast.

### BACKGROUND OF THE INVENTION

1. Field of the Invention

This invention is a walk behind/ride-on high lift truck and functions generally as a vehicle to lift and transport loads of various materials.

2. Description of the Prior Art

Various types of self-propelled, operator controlled fork lift trucks are well known and usually include an operator's seat supported on a frame, operator controls accessible to the operator, a forward generally vertically extending mast with a fork lift assembly movably mounted thereon. Operator controls elevate and lower loads supported by the lift forks movable along the mast with the tilt angle of the mast also controlled by the operator of the fork lift truck. Most fork lift trucks are of the type in which the load on the mast is counter balanced by the weight of the frame, motor and other components of the fork lift truck. Also known is a straddle type fork lift truck in which forward supporting wheels extend forwardly beyond the lower end of a vertically extending mast to provide stable support of the mast. Accordingly, while fork lift trucks are well known, various improvements in the load lifting and the transporting vehicle are desirable as set forth hereinafter for the present invention.

### SUMMARY OF THE INVENTION

The self-propelled, operator controlled, load lifting and transporting vehicle in accordance with the present invention includes a mobile frame supported by front and rear wheel assemblies at the front and rear of the frame and a drive motor on the frame driving a hydrostatic drive system to drive a pair of transversely spaced front wheels. A pair of closely spaced rear wheels are supported from the frame and includes a steering structure oriented to enable operator control. A vertical mast is supported at the front of the frame by a transverse, generally horizontal pivotal structure including a hydraulically operated piston and cylinder assembly to vary the forward and rearward tilt of the mast. A lift frame is vertically movably supported by the mast and is lifted and lowered by a lift chain and a hydraulic piston and cylinder assembly. The lift frame includes an invertible lift fork arrangement to vary the elevation to which the lift forks may lift a load. The rearward portion of the frame is provided with a ride-on operator platform at the rear and a step-on service brake and foot pedal to move the lift frame vertically in relation to the mast.

Operator controls are conveniently located for access by an operator occupying the platform including a hand lever to control movement of the lift frame on the mast, thereby providing both foot and hand control of the lift frame. A mast tilt control hand lever is positioned adjacent the lift control hand lever. The steering structure for the steerable rear wheels includes a handle bar arrangement oriented for ease of grasping by an operator with each end of the handle bar including a throttle control lever. One control throttle lever controls the forward direction and speed of the vehicle and the other throttle control lever controls the reverse direction and speed of the vehicle. A piston and cylinder assembly interconnects the mast and supporting frame and is controlled by a tilt control hand lever adjacent the lift control hand lever for controlling operation of the tilt piston and cylinder interconnecting the lift mast and frame. Masts of various lengths can be easily interchanged and inversion of the lift fork arrangement mounted on the lift frame enables loads to be elevated to an elevation higher than the upper end of the mast for lifting loads to an upper floor or supporting various structures in elevated position while they are being installed in a building structure or the like.

The load lifting and transporting vehicle of this invention also includes pockets in the frame to receive lift forks of a conventional fork lift truck and a lift eye on the frame to facilitate transport of the vehicle and enables the vehicle to be lifted and placed on upper floors of a building or to a desired site. The drive motor and controls are protected by a removable cowl to provide protection for vehicle components, promote air flow, better line of sight for the operator and is easily cleaned, removable for full access to operative components and esthetically pleasing in appearance. Also, a removable fuel tank is provided to enable more rapid re-supply of fuel to the vehicle. A quick change axle extension for the outer dual front wheels allows the wheels to be easily removed so that the vehicle may proceed through doorways; the outer wheels can then be replaced.

One benefit of the load lifting and transporting vehicle of this invention is to transport and lift blocks from a storage area to a mason laying such blocks and may be used both inside and outside of building structures with the weight of the vehicle complying with load ratings for floors so that such load limits are not exceeded. The load lifting and transporting vehicle of this invention provides a safely operated vehicle which can be efficiently controlled by an operator and includes unique controls and other structural features to enable efficient lifting of loads of various materials and transporting such materials to a desired location and then unloading the materials at the desired location.

It is therefore an object of the present invention is to provide a self-propelled, operator controlled, load lifting and transporting vehicle for various materials which includes a mobile frame with transversely spaced front wheels driven by a hydrostatic drive system and a rear wheel assembly that is steerable by a handle bar assembly oriented in accessible position by a ride-on or walk-behind operator.

Another object of the present invention is to provide a vehicle in accordance with the preceding object in which a vehicle frame is provided with a vertically elongated mast at the forward end that supports a vertically moveable load lifting frame thereon with a hydraulically driven mechanism connected to the lifting frame and a hydraulically driven mechanism also controlling forward and rearward tilting of the mast with both the lifting function and tilting function being controlled by an operator.

Still another object of the present invention is to provide a vehicle in which drive components include a drive motor operating a hydraulic pump with various of the drive and control components being protected by a removable cowl to protect the components, and enable access to components, of the vehicle.

A further object of the present invention is to provide a load lifting and transporting vehicle including an interchangeable vertical mast at the forward end thereof which can be converted to different vertical heights to enable a load lifting frame movable on the mast to be elevated to different elevations. The lifting frame includes a fork lift option by which the lifting forks on the lifting frame can be at the lower edge thereof or at the upper edge thereof by inverting the lifting forks to enable loads to be lifted to an elevation higher than permitted by the mast.

A still further object of the present invention is to provide a vehicle in accordance with the preceding objects in which an operator stand on platform is supported at the rear of the vehicle by which an operator can stand on the platform with controls in position for easy and effective access and with the platform also including a transversely extending brake pedal which can be actuated by either foot of the operator to safely and quickly control operation of the vehicle.

An additional object of the present invention is to provide a self-propelled, operator controlled load lifting and transporting vehicle in accordance with the preceding objects in which steerable rear wheels are controlled by a handle bar arrangement with a left and right hand grip with each hand grip including a throttle lever with one throttle lever controlling forward direction and speed of the vehicle and the other throttle lever controlling rearward direction and speed of the vehicle.

Another additional object of the present invention is to provide dual lift controls for the lift frame of the vehicle with one lift control being foot operated and the other lift control being hand operated and a hand operated control for the tilt position of a vertically extending mast at the forward end of the vehicle.

Yet another object of this invention to be specifically enumerated herein is to provide a load lifting and transporting vehicle in accordance with the preceding objects which will conform to conventional forms of manufacture, be of straight forward construction and easy to use as to provide a load lift and transporting vehicle that will economically feasible, strong and long lasting and relatively trouble free in maintenance and use.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTIONS OF THE DRAWINGS

The drawings serve to illustrate the present invention, but are not intended to be drawn to scale.

FIG. 1 is a front and side perspective view of a load lifting and transporting vehicle in accordance with the present invention illustrating the relationship of the mast, lifting frame and lift forks when in their lower position associated with the remainder of the vehicle.

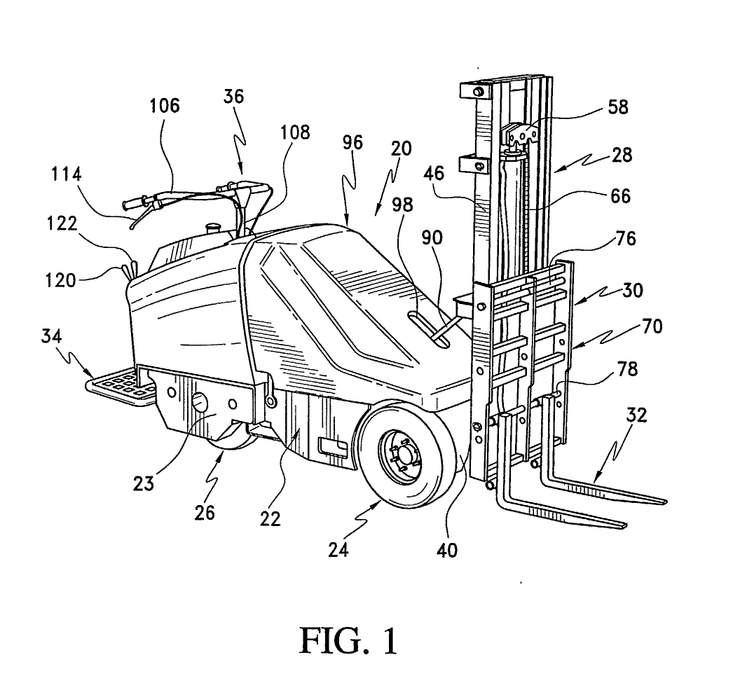

FIG. 2 is a rear and side perspective view of the vehicle of FIG. 1 with the removable cowl removed and illustrating structural details of the vehicle including the mast, lifting frame, lifting eye and other components.

FIG. 3 is an enlarged perspective view of the vehicle similar to FIG. 2, without the mast and lifting frame, illustrating in more detail the specific structure of the operator supporting platform, brake actuator and control structure for the vehicle.

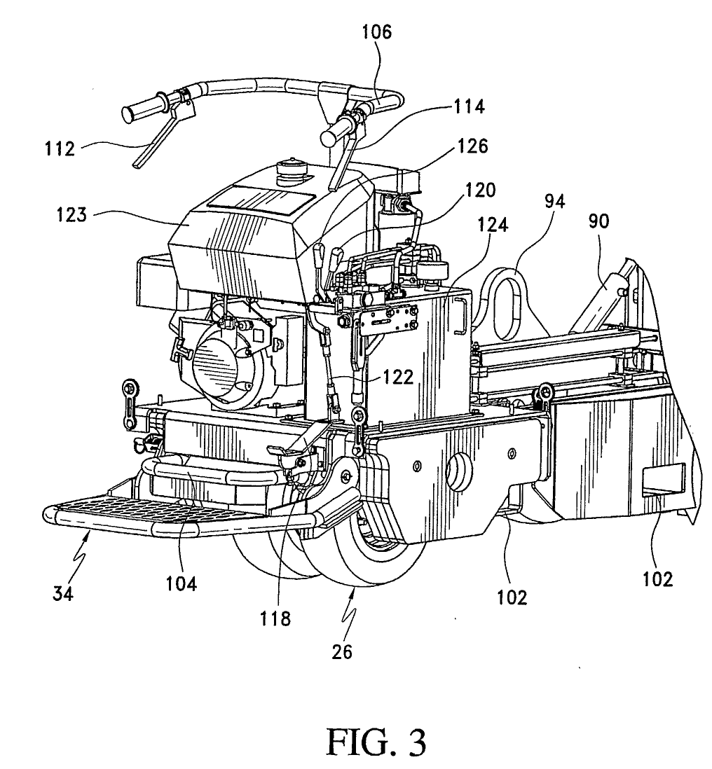

FIG. 4 is a side elevation view of the structure illustrated in FIG. 2 illustrating further structural details of the vehicle.

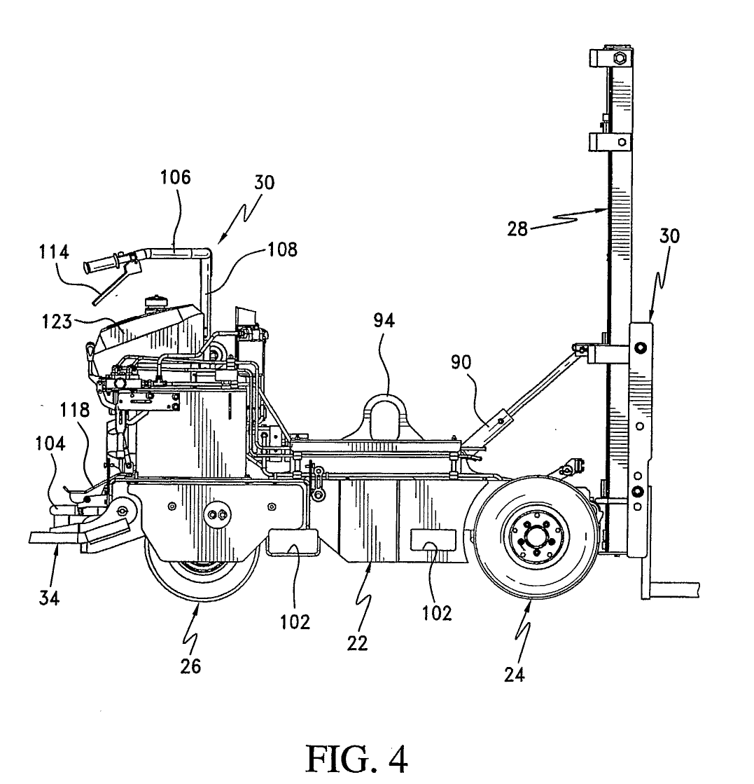

FIG. 5 is a front elevational view of the lifting frame supported on the mast in the vehicle in FIG. 1, with the lift forks oriented at the upper end of the lift frame in elevated relation as compared to that illustrated in FIG. 1.

FIG. 6 is an exploded perspective view of the components of the mast of the vehicle in FIG. 1.

FIG. 7 is an exploded perspective view of the components of the lifting frame and interchangeable lift fork assemblies of the vehicle of FIG. 1.

FIG. 8 is an exploded perspective view illustrating the separation of the cowl from the frame and related supporting structure for the control of the mast and other details of the frame.

### DESCRIPTION OF THE PREFERRED EMBODIMENT

Although one preferred embodiment of the invention is explained in detail, it is to be understood that other embodiments are possible. Accordingly, it is not intended that the invention is to be limited in its scope to the details of constructions and arrangement of components set forth in the following description or illustrated in the drawings. The invention is capable of other embodiments and of being practiced or carried out in various ways. Also, in describing the preferred embodiments, specific terminology will be resorted to for the sake of clarity. It is to be understood that each specific term includes all technical equivalents which operate in a similar manner to accomplish a similar purpose.

Referring specifically to the drawings, the load lifting and transporting vehicle of the present invention is generally designated by reference numeral 20 and includes a frame generally designated by reference numeral 22, supporting and driving front wheels generally designated by reference numeral 24 and a steerable rear wheel assembly generally designated by reference numeral 26. The forward end of the vehicle 20 includes a vertically extending mast generally designated by reference numeral 28 having a load lifting frame generally designated by reference numeral 30 vertically movable thereon. The load lifting frame generally designated by reference numeral 30 includes lift forks generally designated by reference numeral 32 thereon for engaging various loads in order to lift the load to a vertical height within the limitations of the height of the mast 28. The rearward end of the vehicle is provided with a step on platform generally designated by reference numeral 34 to enable an operator to ride on the vehicle or the operator can walk behind the vehicle. Oriented above the platform 34 and forwardly thereof is a handle bar type steering control structure generally designated by reference numeral 36 that controls the pivotal movement of the steerable wheels 26 about a generally vertical axis.

The frame 22, front wheels 24, steerable rear wheels 26, step on platform 34 and other components of the basic vehicle structure are disclosed in copending application Ser. No. 10/231,458 filed Aug. 30, 2002 and having the same assignee as this application. The disclosure in the copending application is incorporated in this specification by reference as if fully set forth therein. The mortar buggy disclosed in the copending application has been modified by removing the pivotal bucket or hopper at the forward end thereof and replacing it with the vertically extending mast 28. The lower end of mast 28 is pivotally connected to the forward end of the frame 22 by pivot structure 40 which includes a transverse tubular member connected to the frame 22 and a pivot member interconnecting the tubular member and mast.

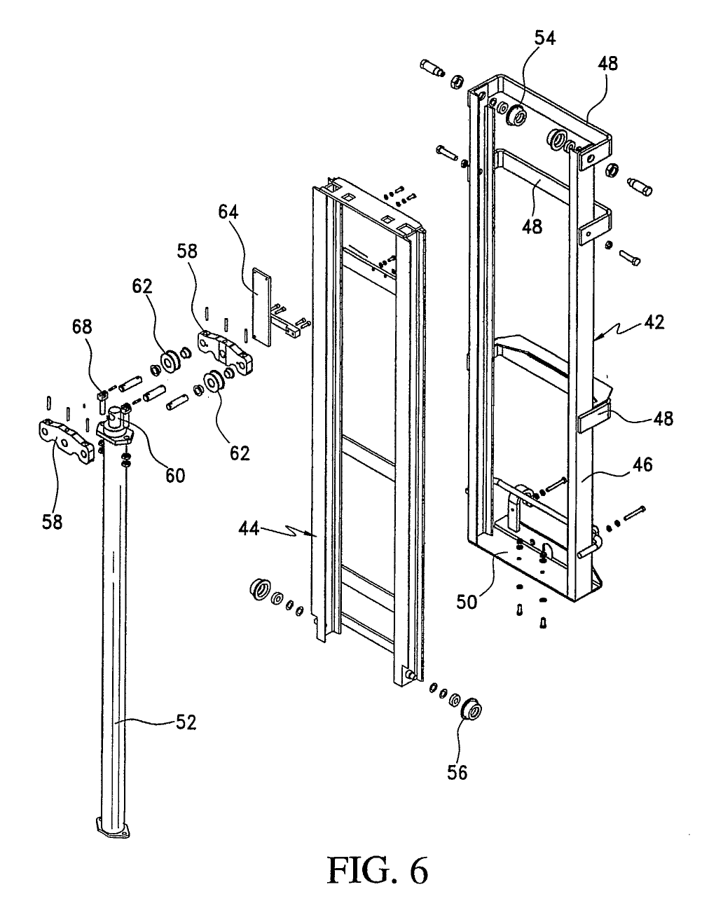

The mast 28 includes an outer vertical column generally designated by reference numeral 42 and an inner vertical column generally designated by reference numeral 44 as illustrated in FIG. 6 with the outer vertical column 42 including a pair of parallel inwardly facing channel shaped members 46 interconnected by transverse member 48 to maintain the members 46 in vertical parallel relation. The lower end of the channel safety members 46 are interconnected by a plate 50 to support a cylindrical mast 52. The upper end of the outer vertical column 42 is provided with inwardly extending guide rollers 54 and the lower end of the inner mast 44 is provided with guide rollers 56. The rollers 54 and 56 guide movement of the channel safety members 46 during relative vertical movement with respect to the inner vertical column 44.

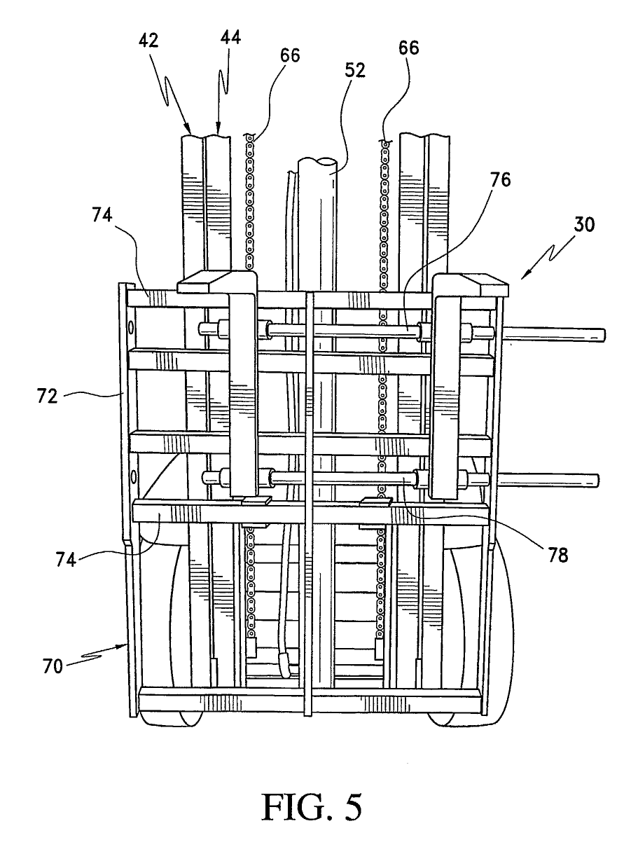

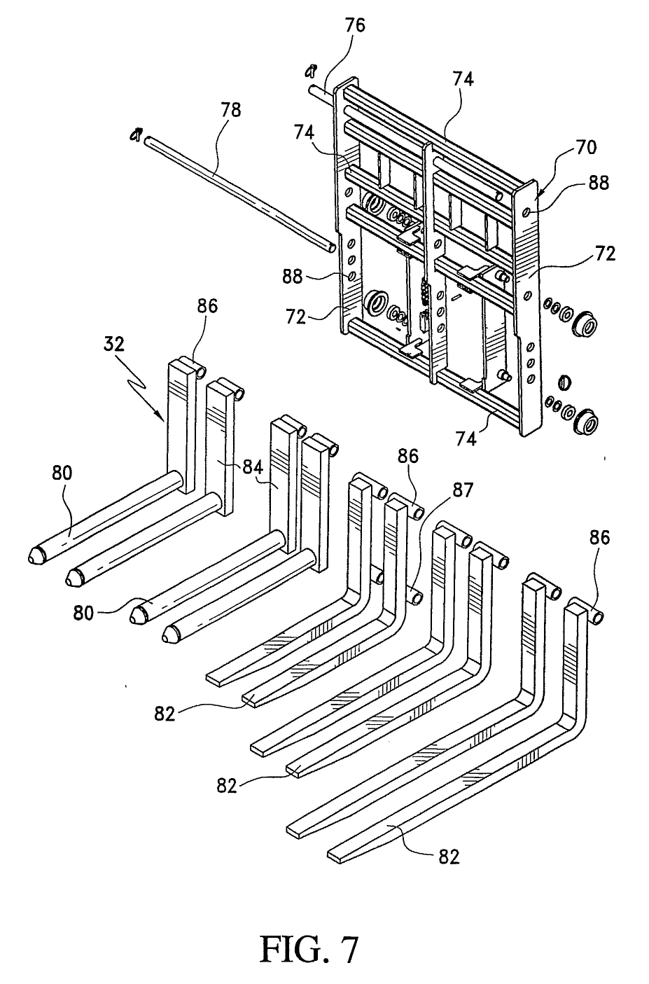

The upper end of the mast 52 is provided with a pair of spaced plates 58 connected to the piston 60 and the cylinder mast 52. The two plates 58 are connected and journal chain rollers 62 and a guide plate 64 is connected to the plates 58. Lift chains 66 are guided by rollers 62 at the upper end with one end of the lift chains 66 being connected to adjustable chain anchors 68 on one of the plates 58. The chain then extends over the rollers 62 with the other ends of the chains 66 extending downwardly and connected to the load lifting frame 30 as illustrated in FIG. 5. The load lifting frame 30 includes a rigid rectangular frame generally designated by reference numeral 70, including vertical side members 72 and a plurality of transverse frame members 74 which are welded together into a rigid unit. An upper support bar 76 and a lower support bar 78 are mounted on the frame 70. A plurality of lift forks 32 are provided for attachment to the support bars. As illustrated in FIG. 7, the lift forks may have a cylindrical lifting component 80 or a rectangular shaped component 82 which extends outwardly from a vertical mounting member 84. A mounting member 84 is attached to each projecting fork 80 or 82 and includes a cylindrical bracket 86 at its upper end which can be slidably mounted on one of the support bars 76 or 78 on the frame 70. The lift forks may be changed by sliding the shaft 76 or 78 out of one of the plurality of vertically spaced apertures 88 in the side members 72 of the frame 70. During normal operation of the lift device, the lift forks 32 are supported from the lower support shaft 78 with the forwardly projecting members 80 or 82 being generally aligned with the lower edge of the frame 20.

The lift forks 32 may be inverted by removing the lift forks 32 from the lower shaft by sliding the lower shaft 78 outwardly. The lift forks 32 are then inverted so that the fork members 80 or 82 are even with the top transverse frame 74 of the frame 70. The forks then being attached to the upper support bar 76 by inserting the upper support bar 76 through sleeves 87 on the vertical component 84 of the lift forks 32 in spaced relation to sleeves 86. The lower support bar 78 is then extended through the side frame members 72 and the sleeves 86 on the lower end of the vertical component 84 of the inverted lift forks 32. Thus, rather than the horizontal components 80 and 82 of the lift forks 32 being generally aligned with the lower transverse frame component 74 and supported on the upper shaft 76, the inverted lift forks 32 have the sleeves 86 supported on the lower support bar 78 and the sleeves 87 on the upper support bar 76. In this position, the horizontal components 80 or 82 on the lift forks 32 are generally in alignment with the upper transverse frame member 74 of the lift frame 70. This enables a load to be lifted by the inverted lift forks 32 to an elevation higher than when the lift forks have their horizontal component 80 or 82 aligned with the lower transverse frame member 74 of the lift frame 70.

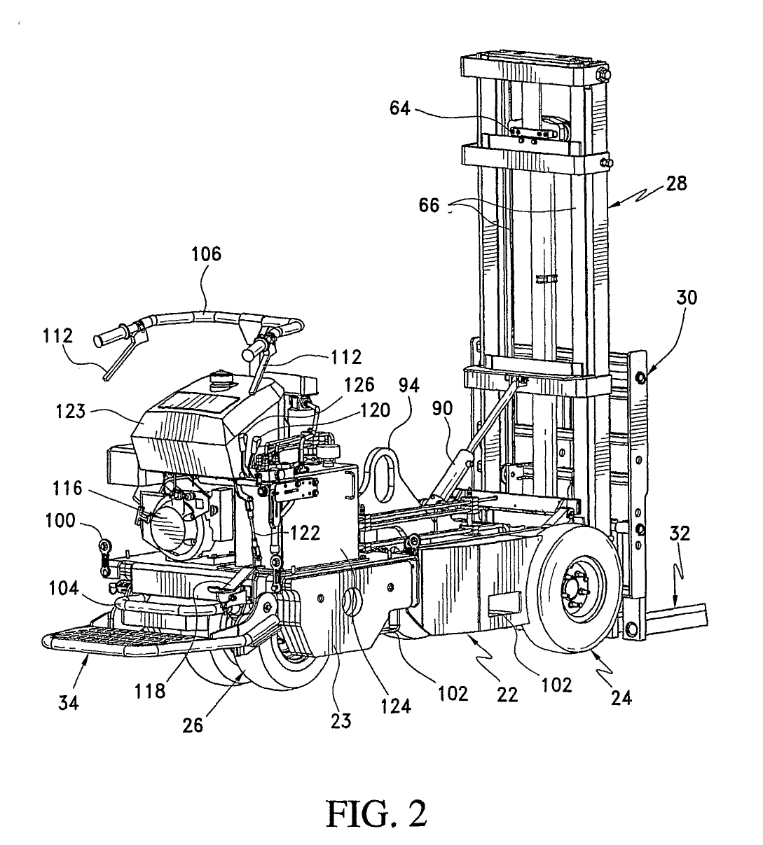

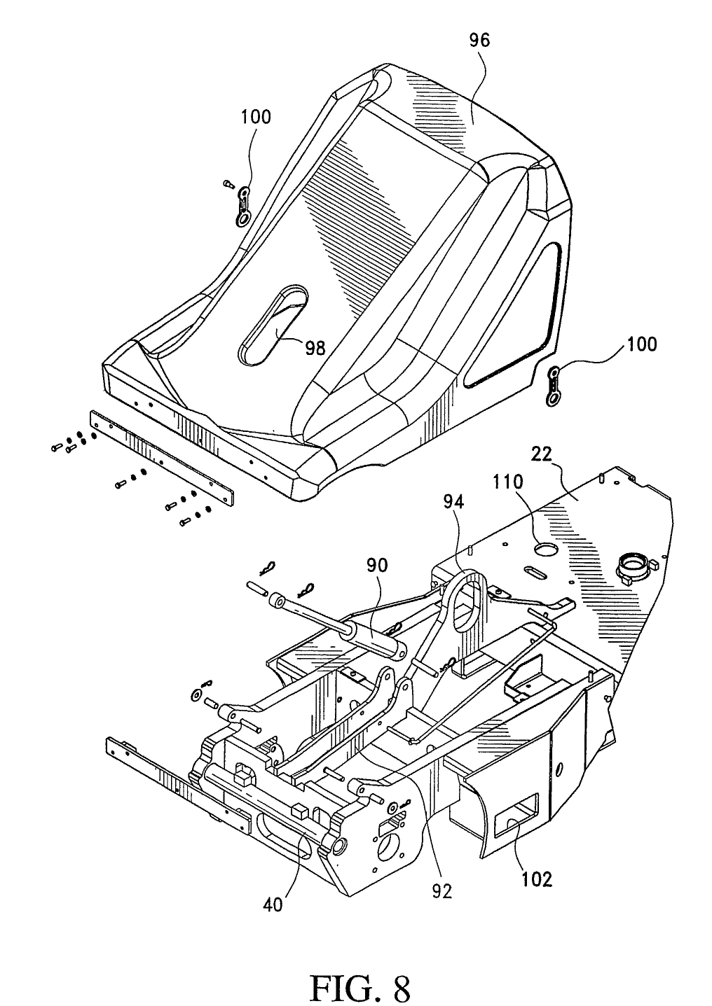

As illustrated in FIG. 2, the mast 28 is pivoted about a transverse horizontal axis by a piston and cylinder assembly 90 extending from a bracket structure 92 on the frame 22 as illustrated in FIG. 8. The cylinder 90 can tilt the upper end of the mast 28 forwardly or rearwardly in order to securely retain a load, such as a pallet, by inserting the forks through the pallet, tilting the mast rearwardly and elevating the lifting frame and load a short distance. The frame 22 is also provided with weights 23 to counter balance the weight of the load on the lifting forks 32. A lifting eye 94 is rigidly affixed to a central portion of the frame 22 to enable the vehicle 20 to be lifted by lifting equipment such as a crane or the like in order to lift the load lifting and transporting vehicle of the present invention onto a large truck, onto an upper floor or lower floor of a building or the like.

FIG. 8 also illustrates a cowl 96 preferably constructed of plastic material or the like which covers the area from which the bucket or hopper was removed from the mortar buggy and encloses various components of the vehicle of the present invention. The cowl includes an elongated large slot 98 in the sloping forward end thereof to receive the piston and cylinder assembly 90 for tilting the mast 28. Also, detachable anchors 100 are provided for securing the cowl to the frame 22 to enable easy removal and assembly of the cowl in relation to the frame to provide immediate and complete access to components of the vehicle underlying the cowl.

The frame 22 also includes parallel openings or bracket structures 102 to receive the forks of a convention fork lift truck to enable the vehicle 20 of this invention to be picked up, lifted and conveyed to a desired location by a conventional fork lift truck.

The ride-on or step-on platform 34 is pivotally supported at the rearward end of the vehicle and a brake actuator 104 is located at the forward end and above the platform 34 to enable a person occupying the platform to use either foot to apply brakes to the front wheels. The platform and brake structure 34 and 104 are the same as that disclosed in the aforementioned co-pending application and operate in the same manner. The operator controls 36 include handle bars 106 attached to the upper end of a vertical steering rod 108 journaled in the frame 22 and extending through an aperture 110 in the frame 22 as illustrated in FIG. 8. The lower end of the rod 108 is connected to the steerable rear wheels 26 to pivot the rear wheels about a vertical axis for steering control of the vehicle in a manner similar to the structure disclosed in the aforementioned co-pending application. The handlebars 106 include a throttle lever 112 on the left end which controls the direction and speed of forward movement of the vehicle and a throttle lever 114 on the right side of the handlebars controls the speed and direction in a reverse direction. Each of the handlebar levers is connected to a cable extending to a control valve in the hydrostatic drive system in which a pressure is maintained by a pump driven by a small internal combustion engine 116 located on the frame 22 above and just forwardly of the platform 34 and brake actuator 104.

Adjacent the right side of the platform 34, a foot operated control pedal 118 is provided for controlling the lifting operation of the mast and load lifting frame. A dual control is also provided for lifting in the form of a hand operated control lever 120 located adjacent a fuel tank 123 and above a hydraulic tank 124 as part of the hydrostatic drive system. The control lever 120 is connected to the foot pedal 118 through a linkage 122 so that the lift operation of the vehicle can be controlled either by using the foot engaged with the foot pedal 118 or manipulating the hand lever 120. The tilt control piston and cylinder assembly 90 is controlled by a hand operated lever 126 adjacent the fuel tank 123 and adjacent the hand lever 120 so that all of the controls for operating the vehicle are easily accessible by an operator of the vehicle riding on the platform or walking behind the vehicle. Suitable control mechanisms for starting the engine 116, operating the engine and stopping the engine and for controlling operation of a hydraulic pump which supplies pressurized hydraulic fluid to hydraulic motors drivingly connected to the front wheels 24. The front wheels 24 are provided with automobile type brakes actuated by the brake actuator 104.

When dual front wheels are used, it sometimes becomes necessary to remove the outer dual wheel at the front end of the vehicle in order to proceed through a doorway or other narrow access through a building opening. When dual front wheel assemblies are used, the outer wheel can be quickly released by utilizing a quick release structure as shown in the aforementioned co-pending application which includes a driving connection to the outer dual wheel and a single fastening device to secure the outer dual wheel in place to enable the outer dual wheel to be easily removed and reattached without the time consuming task of removing and replacing a plurality of lug nuts such as normally used to secure a driving wheel in place.

The foregoing is considered as illustrative only of the principles of the invention. Further, since numerous modifications and changes will readily occur to those skilled in the art, it is not desired to limit the invention to the exact construction and operation shown and described, and, accordingly, all suitable modifications and equivalents may be resorted to, falling within the scope of the invention.

1. A self-propelled, operator controlled, load lifting and transporting vehicle comprising a mobile frame supported by wheels rotatably supported on said frame, a drive motor supported from said frame and driving certain of said wheels, operator controls associated with said drive motor, operator controls connected to other of said wheels to steer the vehicle in a desired path, a generally vertical mast having a lower end supported from a forward area of said frame by a transverse horizontal pivot structure to enable said mast to tilt forwardly and rearwardly in relation to said frame, a power device interconnecting said frame and mast to tilt said mast forwardly and rearwardly about said horizontal pivot structure, said mast including vertically telescopic lift columns with one column being pivotally connected to said frame, a lift frame vertically movably mounted on the other column of said mast, a power unit interconnecting said one column of said mast and lift frame to move said lift frame on said other mast column and said lift frame, lift forks mounted on said lift frame for engagement with a load for lifting and transporting the lifted load to a desired location and lowering the load at the desired location.

2. The vehicle as claimed in claim 1 wherein said drive motor drives a hydraulic pump in a hydrostatic drive system for said driving wheels, said operator controls including separate forward and reverse direction and speed throttle controls.

3. The vehicle as claimed in claim 2 wherein said drive wheels are mounted in transversely spaced relation at a forward end of said frame, each of said drive wheels including a hydraulic motor in said hydrostatic drive system.

4. The vehicle as claimed in claim 2 wherein said steerable wheels include a pair of adjacent wheels underlying said frame at a rearward area thereof, said steerable wheels being supported by a vertical rod extending upwardly and rotatably through said frame, said operator controls including handlebars attached to an upper end of said steering rod, said handlebars including hand grip areas at each end thereof, said throttle controls each including a throttle lever supported adjacent a hand grip to enable an operator to steer the vehicle and operate the direction and speed controls of the vehicle.

5. The vehicle as claimed in claim 1 wherein said lift frame includes a structure supporting said lift forks adjacent a lower edge of said lift frame, each of said forks being of L-shaped configuration with attachment means engaging the lift frame at upper and lower ends of the vertical component of the L-shaped lift forks, said attachment means engaging with the lift frame when the lift forks are inverted with horizontal components thereof generally aligned with an upper edge of said lift frame.

6. The vehicle as claimed in claim 1 wherein said mast include columns nested vertical telescopic side frame members, said power unit including a hydraulic piston and cylinder assembly extending and retracting said side frame members and raising and lowering said lift frame.

7. A load lifting and transporting assembly for a mortar buggy comprising a removable mast adapted to be attached to a forward end of a driven chassis of a mortar buggy, said mast having a lifting frame with lifting forks mounted thereon, said mast being pivotally connected to said chassis at a forward end thereof, a power device interconnecting the mast and chassis to adjust the tilt angle of said mast and a power device vertically, moving said mast and lifting frame to lift a load on said lift forks.

8. A mortar buggy with a high lift truck conversion assembly which comprises
a wheeled chassis;
an engine and controls for driving and steering said chassis;
a hopper pivotally mounted to a forward end of said chassis;
a power driven cylinder to raise and lower a rear portion of said hopper between a transport position and a dumping position;
a high lift truck assembly for pivoted attachment to said chassis and power cylinder for replacing said hopper, said high lift truck including a generally vertical mast having a lower end pivotally mounted to a forward end of said chassis and pivotally connected to said power cylinder for controlling the forward and rearward tilt angle of said mast, a lift frame mounted to said mast for vertical movement thereon, a lift fork assembly projecting forwardly from said lift frame, and a power lift cylinder associated with said mast and lift frame to elevate a load engaged by said lift forks assembly.

9. The mortar buggy with a high lift truck conversion assembly as claimed in claim 8 wherein said controls for driving said chassis includes a rearwardly disposed handlebar, said handlebar including a handgrip and control lever at each end thereof, one of said control levers controlling forward movement and speed of the chassis, the other of said control levers controlling rearward movement and speed of the chassis.

10. The mortar buggy with a high lift truck conversion assembly as claimed in claim 8 wherein said lift fork assembly is supported from the lift frame for selective positioning adjacent a lower edge and an upper edge of said lift frame to vary the elevation to which a load may be lifted by said lift fork assembly.

11. The mortar buggy with a high lift truck conversion assembly as claimed in claim 8 wherein counter balance weight is mounted on said chassis rearwardly of the pivotal connection of said mast with said chassis to enable heavier loads to be lifted and transported.

12. A load lifting and transporting vehicle comprising a mobile frame supported by wheels rotatably supported on said frame, a drive motor supported from said frame and driving certain of said wheels, operator controls associated with said drive motor, operator controls connected to other of said wheels to steer the vehicle in a desired path, a generally vertical mast having a lower end supported from a forward area of said frame by a transverse horizontal pivot structure to enable said mast to tilt fore and aft in relation to said frame, a power device interconnecting said frame and mast to tilt said mast about said horizontal pivot structure, a lift frame vertically movably mounted on said mast, said mast including a pair of vertically telescopic support members, a power unit interconnecting said support members and said lift frame to initially move said lift frame on said mast for a limited distance and then extending said telescopic support members, lift forks mounted on said lift frame for engagement with a load for lifting and transporting the lifted load to a desired location and lowering the load at the desired location.

13. The vehicle as claimed in claim 10 where said power unit includes at least one lift chain having ends connected with a lower end of a vertically stationary support member and said lift frame, a mid portion said lift chains being engaged by said power unit for moving the lift frame said limited distance and then lifting a movable support member, said movement of said lift frame and movable support member being sequential and a vertical distance twice the movement of the point of engagement of the power unit with the mid portion of said lift chain
